(19) United States
(12) Patent Application Publication
(10) Pub. No.: US 2010/0270310 A1
(43) Pub. Date: Oct. 28, 2010

(54) Device for Receiving Food, Production Method Thereof and Use of Same

(76) Inventor: Henri Durouge, Vaison La Romaine (FR)

Correspondence Address: SUGHRUE MION, PLLC, 2100 PENNSYLVANIA AVENUE, N.W., SUITE 800, WASHINGTON, DC, 20037, US

(21) Appl. No.: 11/883,382

(22) PCT Filed: Feb. 1, 2006
(86) PCT No.: PCT/FR2006/000218

§ 371 Date: Jul. 1, 2010

(30) Foreign Application Priority Data
Feb. 1, 2005 (FR) 0500988

(51) Int. Cl. B65D 77/24; B65D 77/04; B31B 7/00

(52) U.S. Cl. 220/495.03; 220/23.87; 493/100

(57) ABSTRACT

The invention relates to a device (5) comprising two similar nestable parts having different thicknesses, namely: a disposable thin part or cap (1) which receives the food, said cap having a resistance that is adapted to the use thereof; and a re-usable base (3) on which the cap (1) is fitted and which is made from a material having a thickness that confers stability and rigidity on the nested assembly (5). Said two parts (1 and 3) are produced using the same cavity. The indispensable cap (1) is applied to the base (3) and inserted between the base and the food, such as to replace a dish. The cap is removed and disposed following use.

The invention relates to an assembly designed for receiving foodstuffs, comprising two portions of different thicknesses, fixedly attached during their effective use, of similar and nestable shapes.

The first essential portion called the cover receives the foodstuffs and the accessories that may be necessary for their consumption. It is made of a material that is thin but sufficiently strong in the form of a strong film for example for the intended use. This removable cover is discardable, therefore not reusable after use. A new cover is put in place on the base with each use.

A second portion that forms the base on which the cover fits is manufactured in a material whose thickness must provide the strength and rigidity of the assembly. This support is recoverable, therefore reusable. Its material is also guaranteed safe for food.

Currently, in similar devices, the cooked foodstuffs are deposited in a weak portion, lacking foundation, of limited stability and even use. Other reusable devices do not have as many food safety guarantees as the present invention.

The assembly according to the invention makes it possible to remedy these disadvantages. Specifically it comprises several novel and defining features.

The two portions, cover and base, are made from at least one cavity portion of compartmentalized shape by molding, machining, stamping or other method. The die is used for machining both the cover and the base, to the required dimensions, irrespective of the materials employed.

The cover, the essential element of the invention, is made of any material making it possible to obtain the strong film on which the cooked foodstuffs will be directly placed. It is removable and is pressed onto the base whose shape, by design, it hugs. It is inserted between the foodstuffs and the base, thereby replacing conventional crockery. Formed from the same cavity of compartmentalized shape as the base, it acquires its rigidity therefrom, remains stable on its support and cannot deform with use.

This single-use cover will be discarded once the foodstuffs have been consumed, thereby providing better hygiene safety. It is made of a material that is guaranteed safe for food according to European standards. It may cover the base partially.

Although the base can be reused at will, a new cover must be put in place with each use.

According to any particular embodiment:
the cover and the base are connected because of their combined use. The materials used will not necessarily be identical. Use may be made of thermosetting, thermoplastic, metallized or unmetallized, polystyrene, metal, compact or corrugated cardboard materials, combinations of both, or any appropriate material preferably recyclable or biodegradable.
for manufacture, all the methods in use, such as injection, thermoforming, molding from one and the same cavity portion of a mold of compartmentalized shape or machining, stamping or pressing with one and the same shape of compartmentalized cavity portion, may be used.
the shape and dimensions of the cover and of its base and the number and volume of the compartments are variable and may be modified on demand according to the particular requirements or according to certain criteria. The assembly may be square, rectangular, oval, round, in a specific plate shape or of any other shape.
the thickness of the cover must be as thin as possible because of the requirements imposed, whatever the material, to optimize efficiency and prevent waste.
white, colored or translucent, this cover may be customized and ornamented with various decorations, logos, brand names or any other symbol.

The appended drawings illustrate the invention. As a nonlimiting example, the following figures illustrate one of the possible models:

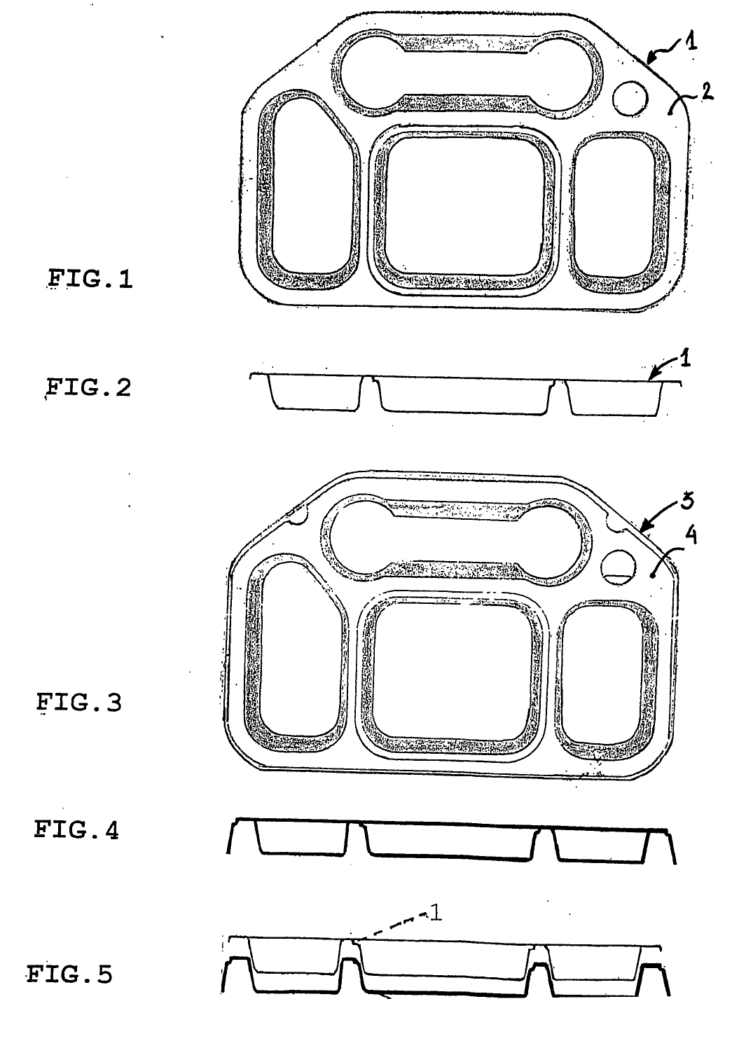

FIG. 1 represents the shape of the cover.

FIG. 2 represents a section of the cover.

FIG. 3 represents the shape of the base.

FIG. 4 represents a section of the base.

FIG. 5 represents in section cover and base of the assembly just before the final nesting is put in place.

These various figures clearly show the two portions of the invention:
the first portion, the cover 1 which receives the foodstuffs, is made of a very thin material 2.
the second portion, the base 3 onto which the cover 1 fits, is made of a material whose thickness 4 ensures the rigidity thereof.
the positioning 5 of the two portions 1 and 3 nested one in the other shows us in section how the cover 1 is presented on the base 3 before it is pressed onto the latter, for a normal use.

The device according to the invention is designed particularly for the foodstuff fields, more specially for the catering service.

In this case, the above example is that of a type of meal tray 5 consisting of a base portion 3 provided with a cover portion 1 according to the invention. Its very simple use offers undoubted advantages in various fields:
on the one hand, the consumer takes his tray 5, chooses his meal (the foodstuffs are placed on the cover 1 and, as appropriate, the accessories), pays, takes it away and sits down, consumes it and then leaves.
on the other hand, the professional who adopts this concept immediately appreciates its value.
as soon as the customer leaves, the clearing of the elements is simplified in the extreme. The person responsible for this task picks up the tray 5 in one hand, while, with the other hand, he removes from the base 3 the cover 1 containing the remains of the meal and disposes of them in a trash can.

The other advantages that ensure yet better efficiency are the following:
elimination of handling crockery and other accessories.
virtually total reduction of washing-up.
saving of water and washing product, resulting in helping to protect the environment.
preparation-time saving in the kitchen.
simplification of the service.
space requirement: the two portions, base and cover of the assembly, that nest in one another, limit the space requirement while making handling and storage easier.
removal of waiting times between ordering, service and the bill.

Consequently, all these advantages promote increased customer turnover.

In the foodstuff field, this invention is perfectly suited to the delivery of cooked meals ready for immediate consumption and is very suitable for catering in general. Amongst other things, it can satisfy enterprises specializing in organizing meetings, superstores, airlines, shipping lines, rail companies, national education, hospitals, retirement homes, but also all national, international or franchized fast food enterprises.

Finally, the absolutely unbeatable minimal cost price of this cover, reinforces the value of the invention.

It will be noted that the device may comprise a lid covering at least the cover 1 or a portion of the latter (not shown), which may or may not be made of the same material as the cover 1, guaranteed safe for food, this lid preferably being shaped to nest without taking up space beneath the base 3 at the mealtime and where necessary support one or more other devices with foodstuffs in order to make single-handed handling easier. This lid may also be compartmentalized for its rigidity, in the same cavity as the base and the cover, where necessary be of a shape identical to the cover apart from the nesting clearance beneath the base, on the one hand making it possible to nest it beneath the base 3 at the mealtime, on the other hand to thermally insulate the hot foodstuffs from the cold foodstuffs on the cover 1.

1. A device or assembly (5) designed for receiving foodstuffs, characterized in that it comprises two similar, nestable portions, of different thicknesses, and fixedly attached during their use, said two similar portions comprising at least the same cavity portion of compartmentalized shape, the first portion called the cover (1) receiving foodstuffs and where appropriate the accessories necessary for their consumption, being removable, the second portion that forms the base (3) receiving the cover (1) nesting therein.

2. The device or assembly (5) as claimed in claim 1, characterized in that the cover (1) receiving the foodstuffs has the thickness of a strong film (2).

3. The device or assembly (5) as claimed in claim 1 or claim 2, characterized in that the base (3) onto which the cover (1) fits has a thickness (4) that provides the strength and the rigidity of the assembly (5).

4. The device or assembly (5) as claimed in any one of the preceding claims, characterized in that the shape and dimensions of the cover (1) and of its base (3) and the number and volume of the compartments are variable.

5. The device or assembly (5) as claimed in one of claims 1 to 4, characterized in that said assembly (5) of the two portions, cover (1) and base (3), is of variable shape.

6. The device or assembly (5) as claimed in any one of the preceding claims, characterized in that said assembly (5) of the two portions, cover (1) and base (3), is of the meal-tray type.

7. The device or assembly (5) as claimed in one of the preceding claims, characterized in that the cover (1) covers the base (3) partially.

8. The device or assembly (5) as claimed in one of claims 1 to 7, characterized in that it comprises a lid that may or may not be compartmentalized, of the same cavity as the base (3) and the cover (1).

9. A method for manufacturing a device or assembly (5) as claimed in one of the preceding claims, characterized in that the two portions, cover (1) and base (3), are molded of synthetic or other material made for the same mold cavity, of compartmentalized shape.

10. The method for manufacturing a device or assembly (5) as claimed in one of claims 1 to 8, characterized in that said portions, cover (1) and base (3), are made by machining or stamping, with the same shape of compartmentalized cavity portion.

11. The method as claimed in claim 10, characterized in that the cover (1) is designed in a variable manner and on demand, according to the base or support (3) available on the market.

12. The use of a device or assembly (5) as claimed in one of claims 1 to 8 to receive foodstuffs, characterized in that the cover (1) is pressed onto the base (3) whose shape, by design, it closely hugs, and the foodstuffs and, as appropriate, the accessories are placed on the cover (1), this cover (1) being designed to be discarded once the foodstuffs have been consumed, a new cover (1) being put in place on the base (3) with each use, the base (3) being designed to be reused.
